(19) United States
(12) Patent Application Publication
(10) Pub. No.: US 2010/0076822 A1
(43) Pub. Date: Mar. 25, 2010

(54) Engine, system and method for generation of brand affinity content

(76) Inventors: Ryan Steelberg, Irvine, CA (US); Chad Steelberg, Newport Beach, CA (US)

Correspondence Address: GIBBONS P.C., ONE GATEWAY CENTER, NEWARK, NJ, 07102, US

(21) Appl. No.: 12/584,725

(22) Filed: Sep. 10, 2009

Related U.S. Application Data
(63) Continuation of application No. 12/079,769, filed on Mar. 27, 2008.
Application No. 12/079,769 is a continuation-in-part of application No. 12/042,913, filed on Mar. 5, 2008.
Application No. 12/042,913 is a continuation-in-part of application No. 12/072,692, filed on Feb. 27, 2008.
Application No. 12/072,692 is a continuation-in-part of application No. 11/981,646, filed on Oct. 31, 2007.
(60) Provisional application No. 60/993,096, filed on Sep. 7, 2007.

(51) Int. Cl. G06Q 30/00; G06Q 10/00; G06F 3/048

(52) U.S. Cl. 705/11; 705/14.42; 705/14.52; 715/760

(57) ABSTRACT

An advertising engine, system and method of using is described. The engine includes at least one vault including a plurality of media assets, a recommendation engine that matches at least one media asset from the vault with at least one requested creative, a delivery engine that integrates the requested creative with the matched media assets from the vault, and a management engine that regulates and/or tracks ones of the at least one media asset.

### CROSS-REFERENCE TO RELATED APPLICATIONS

This application is a continuation of U.S. patent application Ser. No. 12/079,769, entitled “ENGINE SYSTEM AND METHOD FOR GENERATION OF BRAND AFFINITY CONTENT”, filed Mar. 27, 2008, which is a continuation-in-part of U.S. patent application Ser. No. 12/042,913, entitled “ENGINE, SYSTEM AND METHOD FOR GENERATION OF BRAND AFFINITY CONTENT”, filed Mar. 5, 2008, which is a continuation-in-part of U.S. patent application Ser. No. 12/072,692, entitled “ENGINE, SYSTEM AND METHOD FOR GENERATION OF BRAND AFFINITY CONTENT”, filed Feb. 27, 2008, which is a continuation-in-part of Ser. No. 11/981,646, entitled “ENGINE, SYSTEM AND METHOD FOR GENERATION OF BRAND AFFINITY CONTENT” filed Oct. 31, 2007, which is related to concurrently filed U.S. patent application Ser. No. 11/981,837, entitled “AN ADVERTISING REQUEST AND RULES-BASED CONTENT PROVISION ENGINE, SYSTEM AND METHOD” filed Oct. 31, 2007, which claims priority to U.S. Provisional Application Ser. No. 60/993,096, entitled “SYSTEM AND METHOD FOR RULE-BASED GENERATION OF BRAND AFFINITY CONTENT,” filed Sep. 7, 2007, the entire contents of each are incorporated by reference herein as if each set forth in their entireties, respectively.

### FIELD OF THE INVENTION

The present invention is directed to a system and method for branding and advertising, and more particularly, to an engine for accessing and generating brand affinity content, and methods of making and using the same.

### BACKGROUND OF THE INVENTION

High impact advertising is that advertising that best grabs the attention of a targeted consumer. A target consumer is typically identified as the ideal customer for the particular good or service being advertised. This identification can arise from factors such as socio-economics, moral or value bases, age, gender, geography, interest levels or other perspective. The impact on an ideal customer of any particular advertisement may be improved if an advertisement includes endorsements, sponsorships, or affiliations from those persons, entities, or the like from whom the ideal target consumer has an increased likeliness to identify with, seek guidance from, or gain an increased sense of empowerment. Factors that will increase the impact of an endorser include the endorser's perceived knowledge of particular goods, the fame or popularity of the endorser, the respect typically accorded a particular endorser or sponsor, and other similar factors.

Consequently, the highest impact advertising time or block available for sale will generally be time that is associated, such as both within the advertisement and within the program with which the advertisement is associated, with an endorser most likely to have high impact on the ideal target customer. However, the existing art makes little use of this advertising reality.

Thus, there exists a need for an engine, system and method that allows for brand development and the obtaining of an endorsement or sponsorship from specific individuals, entities, brands, marketing partners, or sponsors.

### SUMMARY OF THE INVENTION

An advertising engine, system and method of using is described. The engine includes at least one vault including a plurality of media assets, a recommendation engine that matches at least one media asset from the vault with at least one requested creative, a delivery engine that integrates the requested creative with the matched media assets from the vault, and a management engine that regulates and/or tracks ones of the at least one media asset. The method includes the steps of requesting at least one creative based on at least one information item, matching at least one stored media asset to the at least one creative, integrating the at least one stored media asset to the at least one creative, and regulating the at least one media asset matched to the at least one creative.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 illustrates an exemplary embodiment of the present invention; and

FIG. 2 illustrates another exemplary embodiment of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical advertising engines, systems and methods. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which have been approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

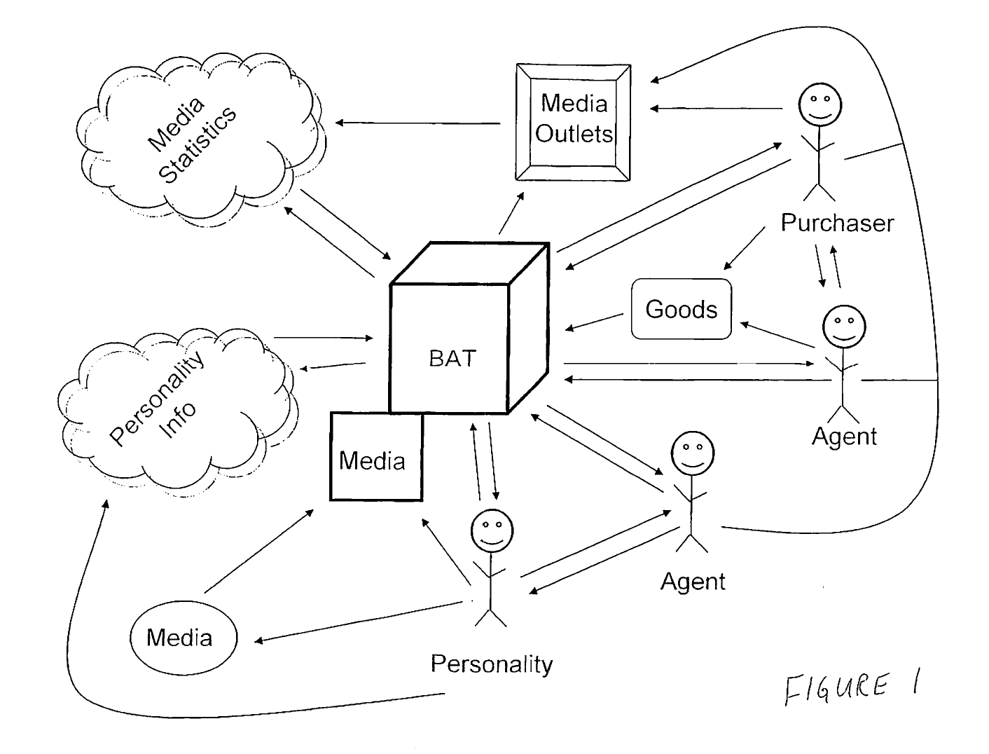

At present, there is a need for a platform or engine to allow for the obtaining of an endorsement, or endorsed ad, in any of the aforementioned circumstances, either from a specific individual, a specific entity, an affinity brand, a marketing partner, or a sponsor. As may be seen in FIG. 1, the development of a targeted advertisement involves a dynamic interrelationship between all relevant factors, such as, for example, the goods, the purchasers, the endorsing personalities and their agents, and the existing or upcoming media associated with each. The ideal advertisement engine must be able to harness and manage all aspects of each of these factors, based upon only a limited number of parameters from which to initiate and generate the advertisement.

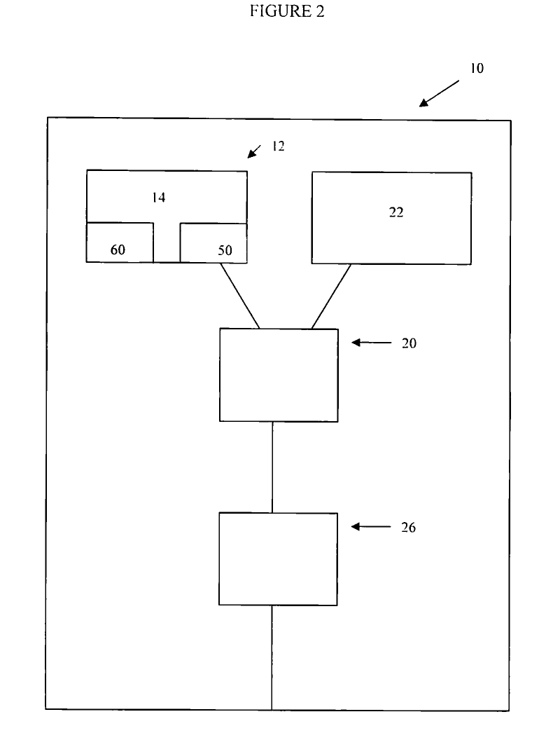

According to an aspect of the present invention, an endorsed advertising engine 10, such as that illustrated in FIG. 2, may include a vault 12 that provides media assets 14 and integration of media assets without need of involving the media assets for permission, a brand association or recommendation engine 20 that may, by creative, by market, by brand affinity, by user request, or otherwise match media assets from the vault with a requested creative/ad 22, and a delivery engine 26 capable of integrating a requested ad 22 with the media assets 14 from the vault 12, late stage binding of the requested ad 22 and media assets 14 upon delivery to strongest target consumers, and delivery of the requested ad 22 and the media assets 16 from the vault to an advertiser or advertising server, which then places the mash up of the ad and media asset. Requested ad 22 may be made via an “ad wizard” using ad templates, as will be apparent to those skilled in the art.

The vault captures certain brands and information related thereto in a common database, such as all major league baseball past and present players, including statistics, video, and pictures of those players affiliated with the names of those players, in addition to any endorsement limitations on those players. The vault may include media assets that may be associated with audio-visual works, including all metadata associated with any media form. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video.

Media assets may further include such items that are predictive of certain future events for purposes of integrating and scheduling certain media assets for maximum value. For example, media assets pertaining to a particular Major League Baseball starting pitcher can identify those locations, days and game start times for that pitcher. Based on this identified schedule, the ad can be requested in advance, and subsequently constructed, delivered and aired on a recurring basis. In another example, media assets may identify a particular golfer who is leading a PGA event prior to the final round. Likewise, the present invention may provide percentage chances of future events to occur based on collected media assets or other collected data, and provide ad requestors the opportunity to identify and utilize endorsers who may have significantly increased value within a relative future timeframe.

The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

According to an aspect of the present invention, media assets associated with particular people, entities or estates may be contractually obligated for endorsement of individual media assets or sets of media assets prior to storage of such assets in the vault. Such contractual obligation may provide for a more streamlined process of media asset recommendation. In another example, such contractual obligation or pre-existing obligation may become part of the media asset descriptor or tag, such that an ad requestor may select or search for only those media assets that do not require further contracting for use in the requested ad. In such an embodiment, the present invention may include a separate management engine or functionality (see further description below) to monitor, review or confirm the presence or absence of contractual matters associated with internal and/or external media assets.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally it may use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from activity data, such as on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling results and/or metadata may provide for local or national focus and maintained in the vault as an associated media asset with a particular brand, and best matches for certain brands may be selected according to such polling results or associated metadata. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

According to another aspect of the present invention, the media assets may be categorized and ranked or tagged for identification by the recommendation engine. For example, the input for the requested ad 22 may be compared with media assets 14, and a weighting or similarity calculation is computed between the requested ad 22 and the media assets 14. Such calculations and comparisons may be made with individual media assets, or with any sort of media asset sets or subsets. Prior to delivery to the ad requester, the media assets 14 with the highest weight values or other similarity comparator relative to the requested ad 22 may be merged into a single deliverable, such as in a list form, where each media asset 14 or media asset set may identify the weight value associated with it. In this exemplary embodiment, weight values may reflect the degree of similarity to the requested ad 22.

The searching function of the recommendation engine for identifying media assets for weighting and ranking may include those tagging and searching tools as understood by those having skill in the art. For example, the media assets may include all forms of metadata, tags, unique descriptors (pointers or identifiers), or even digital representations of the media assets themselves.

In another aspect of the present invention, requested ads 22 may themselves become media assets, and as a further example, such requested ads that become media assets may provide the recommendation engine additional knowledge for future recommendations. This may in effect allow the recommendation engine to “learn” the ad request patterns for providing repeat requestors or similar ad requestor more desirable recommended media assets. In other words, the human aspects of the profiles themselves become media assets and thus provide a feedback loop for increasing the amount of desirous recommended media assets beyond that which can be identified via tags or descriptors.

Similarity calculations may be further constructed to match at different levels of abstraction. In such embodiments, mapping functions may be used to associate particular items in the requested ad 22 to a more general description of a media asset 14 or media asset set. The level of abstraction may be a function of the search parameters, or may be a functionality of the price paid or the complexity of the media asset search requested.

Thus, the recommendation engine may passively or actively inform or otherwise identify the best endorsement matches for a particular user's ads, based on any number of factors, and limited only by the amount and type of information identified in the requested ad. Upon assessment of good matches for the requesting ad or even brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

According to yet another aspect of the present invention, the engine 10 may be used for identifying and recommending a brand itself instead of an ad. For example, the recommendation engine may match media assets from the vault with product identifiers and descriptors entered by a requestor, such that the recommendation engine may identify and match those media assets for branding the product. Results from the recommended branding may then be reentered to the advertising engine 10 via a requested ad 22 as described above to produce an endorsed ad for deliver to an advertiser or advertising server.

The delivery engine 26 may integrate a requested ad with the media asset from the vault pursuant to the actions by the recommendation engine, and can place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as in the event that later stage tracking can further improve ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Because the bids for advertising time in the present invention may vary as discussed above, the present invention lends itself to auction-style placement of advertising, in, which bids are solicited for particular locations, times, or blocks of advertising. Auctions may be held, for example, on line, and may be broken down by media outlet type of ad (i.e. television, internet, etc.), product type of ad, or in any similar manner.

According to another aspect of the present invention, a management engine may be used for performing various managerial functions, such as tracking, reporting, quality control, legal or other regulating mechanisms associated with advertisement engine 10. The management engine may be used within advertisement engine 10 at any point in the recommendation and delivery process, as well as in follow up on delivered or aired ads. The management engine may also act as a regulating body for inclusion or exclusion of media assets prior to storage in the vault.

For example, in one exemplary embodiment, the management engine may be used for tracking media assets during the recommendation and delivery process. The media assets may be tracked by the number of hits they receive for recommendation and or the number of times the media assets are authorized for delivery to the advertiser. The ads themselves may also be tracked by the management engine based on any sort of parameters, using tracking mechanisms as understood by those having skill in the art.

In another exemplary embodiment, reports may be generated, reviewed and delivered to advertisers, endorsers, agents or other third parties, where such reports relate to the various components of the advertisement engine, such as the ads, ad requests, and/or the media assets. Reports may also be based on any tracking records.

The management engine may be used to contact and gain agent approval for particular endorsers, either prior to storage of the associated media assets in the vault, or upon selection of those associated media assets by the recommendation engine in response to the requested ad. The management engine may also verify any parameters associated with contractual obligations attached to the media assets, and may alert the ad requestor, the advertiser, or other party as to the results of such verification.

Such advertisement approval may also include ad review. Such approval and review may include a back end. The back end may include an asset bulk upload, such as wherein a series of media assets are uploaded, such as with attendant approvals required associated with the assets.

Further, the present system may provide for notification rules associated with the approval and review, such as for unique association with ones of the uploaded media assets. As discussed hereinabove, the talent may be notified, pursuant to a rule, of the need to approve the advertisement, and may be asked to acknowledge approval. The system of the present invention may allow for creation of advertisement, and the advertiser may be needed to approve a proposed advertisement after an approval or modification by the talent. The approval and review process may be initiated, either for the talent or for the advertiser, by getting an alert, such as by text or email, for example, that identifies that the campaign has been created, while confirming the date and talent requested. The talent or the advertiser may then be advantageously provided with a single click to see the proposed advertisement and/or in order to approve the advertisement. This single click view may additionally provide reporting information, such as that discussed above, to allow for a single screen view, review of relevant information, and approval.

Further, by way of example, the talent as described herein may have a two-step review and approval process. In such a configuration the talent may be queried to determine if the talent is interested in endorsing/advertising a product. Then the approval may return that either the talent will or will not be interested in endorsing the product. Once the product is determined to be of interest, the advertisement may be created and the talent may further be provided the opportunity to approve and review the created advertisement. This same two-step approval process may be configured for the advertiser as well. For example, if an advertiser is seeking talent to advertise/endorse a product the advertiser may be queried about the use of a certain talent. Upon approval of the talent the advertisement may be created and the advertiser again may approve and review the created advertisement.

The management engine may also be used to screen existing media assets in the vault and filter or even remove media assets from the vault. For example, if a media asset is determined to have a tag or descriptor that is no longer relevant, or is otherwise incorrect, the management engine may remove the tag or descriptor, or even remove the media asset from the vault entirely.

A valuation methodology may be employed in accordance with the present invention in order to valuate branded entertainment transactions. The prior art currently offers no industry standard. Branded entertainment to be valuated in accordance with the present invention spans all media plays discussed herein, including air television, cable, film including but not limited to feature films, radio, music and music videos, and video games, in domestic and foreign markets, by way of non-limiting example only. Thus, as used herein throughout, the terms viewer and/or listener may be used interchangeably to refer to any recipient of any of the aforementioned media plays.

The first step in a valuation methodology is to identify the quantifiables that may be used. For example, the attributes associated with a branded media placement discussed herein throughout may include how many seconds the media placement appeared, whether it was in the foreground or background or whether the product, service, or usage appeared alone on the screen, the size and visibility of the placement, whether there was any interaction between the product, service, or usage and the actors, singers, or the like, the creative quality of the integration, the competitive images or sounds used, whether there is implied celebrity endorsement for the brand, viewer response and whether there was a visual placement or brand mention in the context of the dialogue. Ratings of the entertainment during which the placement occurred may also be used as will be evident to those possessing an ordinary skill in the pertinent arts in light of the disclosure herein. Further a brand content measuring tool may provide impact of the product integration through consumer research on the brand awareness and affinity rather than assign a dollar value to the integration.

For example, quantifiables for branded media play may include the program rating for the show during which the branded placement occurred. This quantifiable may be pinpointed process such that the ratings for the minute when the product placement is accounted for and may even include the demographic profile of the viewing audience at the time the placement took place. Numerous factors may be used for the exemplary quantifiables and may be valued to the minute or even the hundredth of a second of an integration, which level of pinpointing may be selectable by one or more users of the present invention, and which such selectable pinpointing will vary in accordance with the particular quantifiable of interest. Scores for each quantifiable may be provided, such as assigning a score on a scale ranging from 1-10, for example.

Other quantifiables include predicting audience size for a given advertisers group, then defining cost based on the average rates to reach a demographic through a 30 or 60 second spot on television. A dollar value for the integration based on its forecasted audience size may then be calculated and data collected on the various characteristics of the placement. This provides a value metric that may be placed on a per-second spot, such as for a 30 second spot, for example. Metrics may be used in guiding this type of valuation, such as the cost of another television ad on the same show, for example. Such a numeric metric may be used in whole, or may be metered to account for the fact that the placement may not encompass the entire advertising spot, such as wherein the placement accounts 25% of an ad, for example. Such metering may include values as low as 1% or lower, for example, depending on the user selected pinpointing level. When placements in non-characteristic advertising markets—those where advertising spots may not be used as a metric—are used, a standard rating of cost per viewer factor, such as one ranging from $0.01-$2 may be used to value placement and sponsorship opportunities, for example.

Yet another quantifiable of fixed cost per minutes may also be used. Such fixed factors may be $1, 10, 20, or 100 CPM, for example. Such a fixed cost may also be varied based on given markets, countries and medium as would be evident to those possessing an ordinary skill in the pertinent arts. Further, predictive techniques may be used to predict audience size for advertisers or an agreement to a fixed advertising cost per thousand (CPM) based on the average rates to reach the film's demographic through a 30-second spot on television, for example. Factors similar to those discussed above may be used to vary the rate by accounting for known research parameters, viewer response to polled advertising, and comparison to similar type placements performed previously.

Quantifiables may be equally or unequally weighted, and a score for each may be translated into an overall score for the placement. Further, the quantifiables may be weighted based on known, studied, hypothesized, or other biased weighting, and then the score for each may be translated into an overall score after accounting for the weighting.

Other valuation methods may provide no value for a placement, but instead provide data on viewer response to product integrations and then translate this response into a score that advertisers may use as a quantifiable in conjunction with their own sales and marketing data to determine, for example, return on investment. Such techniques may utilize response data, such as whether the audience remembered the placement, i.e. consumer recall; whether the audience could associate the placement with the brand, i.e. brand recall; and whether the audience felt the placement represented a proper fit with the show.

Information may be compiled from selling brands worn, placed, featured or utilized in particular movies, television programs and the like to provide data that can help brands and entertainment companies put a value on these placements. A database of such information may be created that includes information on quantifiables describing the placements, as discussed hereinabove. Based on such information, and the number of viewers who purchased, viewed or showed interest in a product that appeared gauged via an Internet-based shopping service, for example, transactional data may be logged to demonstrate whether the placements were effective in creating demand for the product. Such enhanced information may in turn lead to predictive models based on this historical transactional data to aid in determining the kinds of product placements that will be successful. Such predictive modeling may be made available to subsequent users of the present invention, such as by placement into ad templates, suggested partners, regionalized brand affinities, and the like.

As will be apparent to those skilled in the art, the engines within the endorsed advertising engine of the present invention may draw on any number of communication access points and media sources, including wired and wireless, radio and cable, telephone, television and internet, personal electronic devices, satellite, databases, data files, and the like, in order to increase content in the vault, contribute content for intelligent selection of brand associations, and best allow for recommendations and delivery.

Geo-targeting may also be utilized to manage geographically constrained or geographically targeted marketing and advertising campaigns. Those skilled in the art will understand that such campaigns may also be included as all or a portion of a campaign that is not geographically constrained, but the exemplary embodiment herein will be described with respect to a geographically constrained approach. A non-limiting example of a geographically constrained market for the purpose of discussing this exemplar embodiment is the National Football League. Under the marketing rules of the National Football League, individual teams are permitted to market their individual teams, the NFL, logos, jerseys, colors, and players, by way of non-limiting examples only, in the respectively named markets for each respective team without seeking the approval of the NFL. Therefore, in the event the geographic location of a user is identified in accordance with the present invention, a campaign or other creative may be constructed to provide specific reference to the particular NFL team having rights in the identified market of the online user, for example, without seeking approval of the NFL. Such a configuration allows real-time marketing campaigns and reduces the time necessary for creation of such campaigns.

Geo-targeted advertising according to the present invention includes determination of a user's geographical position. Such a determination identifies a geographical location within a predetermined accuracy threshold, such as by country, region, city, latitude, longitude, ZIP code, time zone, connection speed, ISP and domain, such as by using an IP address lookup database or similar technology without invading the user's privacy, for example. More specifically, in computer networking, IP addresses may not correspond to a geographic location within the desired accuracy threshold, wherein a server is not proximate to or co-located with the user, but a conversion may be performed to determine the physical location of IP addresses in many cases. Yet more specifically, geo-location may attempt to map IP addresses to geographic locations using large computer databases. For example, webmasters may use geo-location to track the geographic distribution of visitors to their site, and in addition may be able to dynamically change or block the content shown to each visitor based on location. In other embodiments of the present invention, a user's location may be assessed by cellular or other GPS or triangulation systems, by a cable television, DVR, or other set top box, by sending a “ping” signal or the like.

Once a geographical position is determined, such data may be input into the campaign creation tool. In such a tool, as the campaign is created the assessed geographical location becomes an input in determining whether a particular advertisement or spokesman may be utilized in a creative, or must be changed upon delivery of a creative to a user. Referring again to the example above, if the geographical location is determined to be a location that does not require further NFL authorization to allow delivery of a particular creative, an advertisement may be delivered that uses the colors or jersey of the Dallas Cowboys to the user in Dallas, for example. Further, such an advertisement may be designed to include the use of a Dallas player, such as Tony Romo, for example. However, rules may block, limit, replace, or otherwise edit the creative for delivery to users near, or far, from Dallas. Such geo-targeting greatly increased the available spokesmen and endorsement services available in delivering online advertisements. Such geo-targeting allows for geographically constrained marketing and advertising campaigns. Further to the example described above, the Dallas Cowboys are allowed to market Dallas Cowboys, the NFL, logos, jerseys in certain named markets, such as in Dallas. Once the geographical position is determined to include these certain named markets, an advertisement with Tony Romo in his jersey may be provided without prior approval of the NFL, in the exemplary embodiment.

As would be evident to those possessing an ordinary skill in the pertinent arts, IP addresses, such as IP or DVR address, may be associated with a location in a somewhat inaccurate manner (e.g., the wrong postal code, city or suburb within a metropolitan area) to allow for the required precision for a particular creative. Similarly, IP addresses may be associated only with a very broad geographic area (e.g., a large city, or an entire state). Many precise addresses may be associated with a city, thus not allowing for assessment of a street address or latitude/longitude location. “Hotspots” may also be used, but present similar issues and often map to SSID information instead of discrete locations. Further, some addresses will not appear in an IP database, for example, and therefore cannot be mapped. In such situations, depending on the underlying licensing issues or rules selected surrounding the campaign generation, advertising may be by rule included or excluded. Using the example of the Dallas Cowboys above, if an IP address cannot be mapped into one of the specific zones that the Dallas team is eligible to advertise without prior approval, such ads may instead be handled using other aspects of the brand delivery system. Alternatively, if the mapping merely to within the city comes completely within the zone of acceptable advertising, the ad may be delivered.

Needless to say, in the event, discussed immediately hereinabove, that inadequate precision is all that is available for use with the present invention from one discrete geo-locating methodology, multiple methodologies may be employed, either hierarchically or in conjunction, in order to obtain the desired or required precision. For example, IP addressing may be used in conjunction with one or more of GPS, triangulation, hot spotting, user entered location value, set top box location, telephonic locating, computing “cookies”, sending a “ping” and receiving a return, tracking of previous location(s), or the like.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

1. An advertising engine, comprising:
at least one vault, associated with at least one computerized memory, comprising a plurality of computer readable media assets, wherein at least one processor matches at least one media asset from the vault with at least one requested creative; and
a review and approval engine that provides, to at least one subject of the matched media asset at a single view, the requested creative integrated with the matched media assets from the vault for review, a reporting of information associated with the integrated requested creative, and an approval click that allows for subsequent delivery of the integrated requested creative.

2. The advertising engine of claim 1, wherein the matching performed by the at least one processor comprises a weighting of the plurality of media assets.

3. The advertising engine of claim 1, wherein the media assets comprise brands other than a brand of the requested creative.

4. The advertising engine of claim 1, wherein the media assets further comprise a computer data indicative of a tag.

5. The advertising engine of claim 1, wherein the matching performed by the at least one processor comprises a ranking of the plurality of media assets.

6. The advertising engine of claim 1, wherein the media assets further comprise a descriptor.

7. The advertising engine of claim 1, wherein the media assets comprise payment schema.

8. The advertising engine of claim 7, wherein the payment schema vary based on a requester of the requested creative.

9. The advertising engine of claim 1, wherein the at least one processor engages in matching based on exclusions of the media assets, and at least one of secondary information external to the vault and variable factoring.

10. The advertising engine of claim 9, wherein the variable factoring comprises a brand association between the media asset's brand and a brand of the requested creative.

11. The advertising engine of claim 1, wherein each media asset comprises a profile of that media asset.

12. The advertising engine of claim 11, wherein each of the profiles comprises at least a psychological profile of typical users of that media asset's brand, target customers of that media asset's brand, and target affiliate profiles.

13. The advertising engine of claim 12, wherein the target affiliate profile comprises at least two of desired sharing of marketing costs, desired increasing brand recognition in certain geographies, desired increasing brand recognition in certain fields of use, distribution channel access, expedited market entry, and improved brand perception.

14. The advertising engine of claim 1, wherein at least two of the matches are presented for selection of one of the matches.

15. The advertising engine of claim 1, wherein said review and approval engine comprises a back end focus.

16. The advertising engine of claim 1, wherein said review and approval engine comprises a set of notification rules.

17. The advertising engine of claim 16, wherein said set of notification rules comprises at least one alert to indicate the creation of the campaign.

18. The advertising engine of claim 17, wherein said alert confirms the date and talent requested.

19. The advertising engine of claim 17, wherein said alert includes a clickable link to the proposed advertisement to thereby provide opportunity to review.

20. The advertising engine of claim 1, wherein review and approval engine comprises a two-step review process.

21. The advertising engine of claim 20, wherein said two-step review process is for the talent.

22. The advertising engine of claim 20, wherein said two-step review process is for the advertiser.

23. The advertising engine of claim 20, wherein said two-step review process include a first step of querying the talent to determine if interested in endorsing a product.

24. The advertising engine of claim 20, wherein said two-step review process includes a second step of providing the talent an opportunity to review the created advertisement.

25. A method of generating an advertisement, comprising the steps of:
requesting at least one creative based on at least one information item;
matching at least one stored computer readable media asset to the at least one creative;
integrating the at least one stored media asset to the at least one creative;
regulating the at least one media asset matched to the at least one creative; and
reviewing and approving the at least one media asset matched to the at least one creative;
wherein said matching, integrating and regulating are performed by at least one processor.

26. A targeted media generator, comprising:
at least one vault associated with at least one computerized memory comprising a plurality of computer readable media assets;
a recommendation engine that matches at least one media asset from the vault with at least one requested creative;
a delivery engine that integrates the requested creative with the matched media assets from the vault; and
a management engine that regulates at least one aspect of the requested creative and at least one matched media asset;
wherein said recommendation, delivery and management engines are associated with at least one processor, and wherein said management engine provides for at least one of advertisement review and approval, and
wherein said management engine includes at least one of advertisement review and approval.
